(19) United States
(12) Patent Application Publication
(10) Pub. No.: US 2023/0011947 A1
(43) Pub. Date: Jan. 12, 2023

(54) DECODING METHOD, DECODING APPARATUS, AND PROGRAM

(71) Applicant: Nippon Telegraph and Telephone Corporation, Tokyo (JP)

(72) Inventors: Mayuko WATANABE, Musashino-shi, Tokyo (JP); Ryuichi TANIDA, Musashino-shi, Tokyo (JP); Hideaki KIMATA, Musashino-shi, Tokyo (JP)

(21) Appl. No.: 17/783,496

(22) PCT Filed: Dec. 9, 2019
(86) PCT No.: PCT/JP2019/048108

§ 371 Date: Jun. 8, 2022

(51) Int. Cl. G06T 9/40

(52) U.S. Cl. CPC G06T 9/40

(57) ABSTRACT

Disclosed is a decoding method for decoding encoded data obtained by encoding a cube that includes three-dimensional point cloud data. The decoding method includes a step of obtaining point occupation states of solids obtained after division in one direction, from the encoded data, wherein the direction of the division is determined based on correlation among the point occupation states of the solids after the division. Another decoding method and a decoding apparatus are also disclosed.

### TECHNICAL FIELD

The present invention relates to a decoding method, a decoding apparatus and a program.

### BACKGROUND ART

Contents in which a three-dimensional object is displayed in virtual space have been widespread. As a method for expressing a three-dimensional object in virtual space, point cloud data is known. The point cloud data is a collection of points in three-dimensional space. Since the amount of data is large if point cloud data is used as it is, it is thought to encode a cube that includes the point cloud data with an octree structure.

In the octree structure, a cube that includes all point cloud data is created and divided into eight cubes (hereinafter, the divided cubes will be referred to as boxes) by dividing each side into two equal parts. Each of boxes that include a point is further divided into eight. Boxes that do not include a point are not divided. The cube is expressed by a numerical value based on the point occupation states of the boxes (whether the boxes include a point or not). When the point occupation state is indicated by a 1-bit numerical value, the cube is indicated by an 8-bit numerical value (from 0 to 255). Each of the further divided boxes is indicated by an 8-bit numerical value. By arranging the 8-bit numerical values in descending order with the top hierarchical layer (the largest cube) first, the point cloud data can be encoded.

### CITATION LIST

### Non-Patent Literature

Non-Patent Literature 1: “Information technology—MPEG-I (Coded Representation of Immersive Media)—Part 9: Geometry-based Point Cloud Compression”, ISO/IEC JTC 1/SC 29/WG 11

### SUMMARY OF THE INVENTION

### Technical Problem

In view of the structure of an object in real space, however, there are many cases where, though points successively exist in a particular direction, points continuously do not exist in an adjoining area, like an edge. In such cases, a boundary between an area in which points exist and an area in which points do not exist may be included in one box. As a result, boxes having coordinates at which a point exists and coordinates at which a point does not exist successively exist, corresponding to the magnitude of the edge, and there is a possibility that encoding efficiency decreases.

The present invention has been made in view of the above, and an object is to improve encoding efficiency of point cloud data.

### Means for Solving the Problem

A decoding method of one aspect of the present invention is a decoding method for decoding point cloud data from encoded data obtained by dividing a cube that includes three-dimensional point cloud data into n (n is an integer equal to or larger than 2) in order of a first direction, a second direction and a third direction and encoding point occupation states, wherein a computer executes the steps of: determining the first direction, the second direction and the third direction according to order of decoding; obtaining a point occupation state of each of n first block groups obtained by dividing the cube into n in the first direction; obtaining, according to the point occupation state of each of the first block groups, a point occupation state of each of n second block groups obtained by dividing the first block group into n in the second direction; and obtaining, according to the point occupation state of each of the second block groups, a point occupation state of each of n blocks obtained by dividing the second block group into n in the third direction.

### Effects of the Invention

According to the present invention, it is possible to improve encoding efficiency of point cloud data.

### BRIEF DESCRIPTION OF DRAWINGS

FIG. 1 is a diagram showing a cube that includes point cloud data.

FIG. 2 is a diagram in which the cube is divided in a z-axis direction.

FIG. 3 is a diagram in which a 4×4 block plate is divided in an x-axis direction.

FIG. 4 is a diagram in which a 4×1 block row is divided in a y-axis direction.

FIG. 5 is a diagram showing an example of a structure of encoded data that is decoded by a decoding apparatus of the present embodiment.

FIG. 6 is a diagram showing an example of decoding information included in a header.

FIG. 7 is a functional block diagram showing a configuration example of the decoding apparatus of the present embodiment.

FIG. 8 is a flowchart showing a flow of a process of the decoding apparatus of the present embodiment.

FIG. 9 is a diagram in which the cube is divided in the x-axis direction.

FIG. 10 is a diagram in which an 8×8 block plate is divided in the y-axis direction.

FIG. 11 is a diagram in which an 8×1 block row is divided in the z-axis direction.

FIG. 12 is a flowchart showing a flow of a process of a point cloud data encoding method.

FIG. 13 is a diagram in which the cube is divided into 8×8×8 blocks.

FIG. 14 is a flowchart showing a flow of a process of a point cloud data encoding method.

FIG. 15 is a diagram in which the cube is divided into eight.

FIG. 16 is a diagram in which each of two cubes is divided into eight.

FIG. 17 is a diagram showing an example of a hardware configuration of the decoding apparatus.

### DESCRIPTION OF EMBODIMENT

An embodiment of the present invention will be explained below using drawings.

Encoded data to be decoded in the present embodiment is data encoded by dividing a cube that includes three-dimensional point cloud data into n (n is an integer equal to or larger than 2) in each of coordinate axis directions. Specifically, the encoded data of the present embodiment has been encoded based on the point occupation state of each of solids (n×n block plates, n×1 block rows and 1×1×1 blocks) obtained by, after dividing a cube into n in any of the coordinate axis directions, dividing each of divided solids (the n×n block plates) into n in any coordinate axis direction that is parallel to a divided surface and further dividing each of divided solids (the n×1 block rows) into n cubes (the 1×1×1 blocks or blocks).

[Encoded Data]

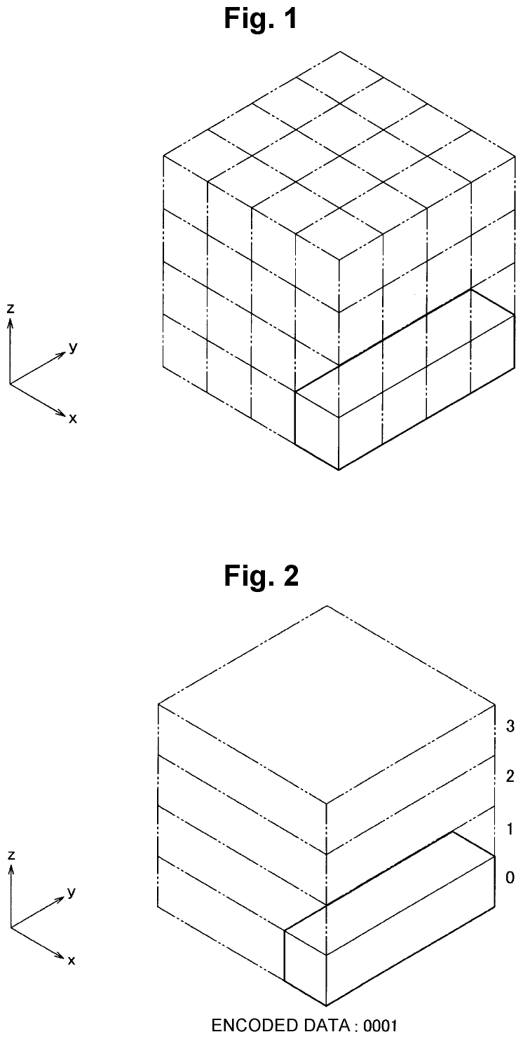

Encoded data of the present embodiment will be explained using a specific example with reference to FIGS. 1 to 4.

It is assumed that blocks that include a point are arranged in a y-axis direction as shown in FIG. 1. A cube that includes these blocks is divided and encoded. Explanation will be made below with the number of divisions n as 4.

FIG. 2 shows an example of division of the cube. In the example of FIG. 2, the cube is divided into four 4×4 block plates in a z-axis direction. As for the point occupation state of each of the 4×4 block plates, a solid that includes a point is indicated by 1, and a solid that does not include a point is indicated by 0. When numerical values indicating the point occupation states of the solids obtained by dividing the cube into four are arranged with the positive direction of the z axis regarded as indicating a higher-order bit, the cubic is indicated by “0001”.

Among the 4×4 block plates, a 4×4 block plate that includes a point is further divided and encoded. In the example of FIG. 2, only the bottom 4×4 block plate is further divided.

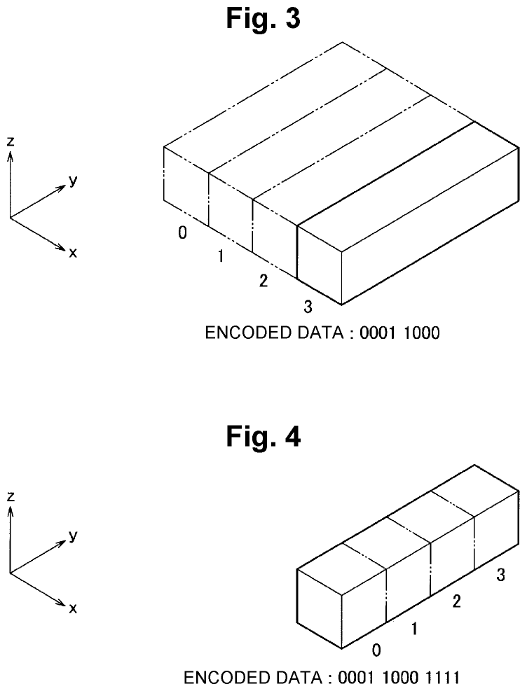

FIG. 3 shows an example of division of the 4×4 block plate. In the example of FIG. 3, the 4×4 block plate is divided into four 4×1 block rows in an x-axis direction. As for the point occupation state of each of the 4×1 block rows, a solid that includes a point is indicated by 1, and a solid that does not include a point is indicated by 0. When numerical values indicating the point occupation states of the solids obtained by dividing the 4×4 block plate into four are arranged with the positive direction of the x axis regarded as indicating a higher-order bit, the 4×4 block plate in FIG. 3 is indicated by “1000”.

Among the 4×1 block rows, 4×1 block rows that include a point is further divided and encoded. In the example of FIG. 3, only the rightmost 4×1 block row is further divided.

FIG. 4 shows an example of division of the 4×1 block row. In the example of FIG. 4, the 4×1 block row is divided into four blocks in the y-axis direction. As for the point occupation state of each of the blocks, a solid that includes a point is indicated by 1, and a solid that does not include a point is indicated by 0. When numerical values indicating the point occupation states of the solids obtained by dividing the 4×1 block row into four are arranged with the positive direction of the y axis regarded as indicating a higher-order bit, the 4×1 block row in FIG. 4 is indicated by “1111”.

By arranging numerical values obtained by encoding the solids, encoded data of the present invention is obtained. The cube in FIG. 1 is indicated by twelve bits of “0001 1000 1111”. A header showing the order of having divided the cube, that is, order of decoding is given to the data. In the above example, a header showing the cube is to be decoded in the order of the z axis, the x axis and the y axis is given.

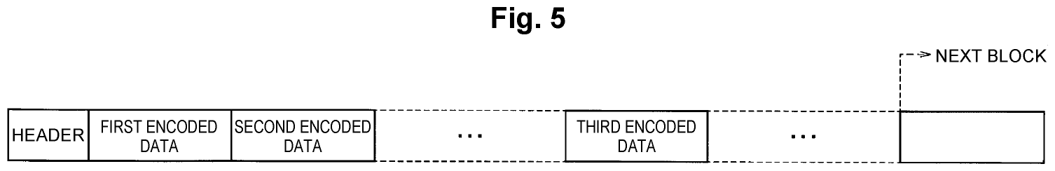

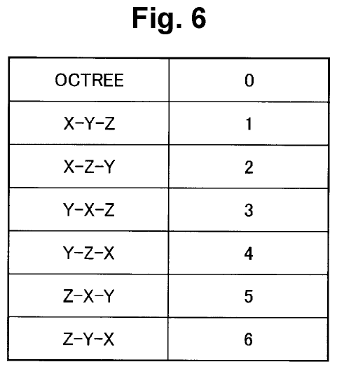

FIG. 5 shows an example of a structure of encoded data. The encoded data in FIG. 5 is configured with a header, first encoded data, second encoded data and third encoded data. The header includes decoding information showing a decoding method and a decoding direction. FIG. 6 shows examples of the decoding information. In the example of FIG. 6, 0 indicates that decoding is to be performed with a conventional octree; and 1 to 6 indicate order of decoding directions. For example, in the example of FIGS. 1 to 4, decoding is performed in the order of the z axis, the x axis and the y axis, therefore, a value of the decoding information is 5. The configuration of the encoded data in FIG. 5 and the header in FIG. 6 are mere examples, and the configuration and the header are not limited thereto.

The first encoded data is data obtained by encoding the point occupation state of each of n×n block plates obtained by dividing a cube into n. In the example of FIGS. 1 to 4, “0001” obtained by encoding the point occupation state of each of the four n×n block plates obtained by dividing the cube into four in the z-axis direction is the first encoded data.

The second encoded data is data obtained by encoding the point occupation state of each of n×1 block rows obtained by dividing each of n×n block plates that include a point into n. In the example of FIGS. 1 to 4, “0001” obtained by encoding the point occupation state of each of the four n×1 block rows obtained by dividing the 4×4 block plate into four in the x axis is the second encoded data. The number of pieces of second encoded data corresponding to the number of n×n block plates that include a point exists. For example, when two n×n block plates include points, two pieces of second encoded data exist and are arranged in predetermined order.

The third encoded data is data obtained by encoding the point occupation state of each of blocks obtained by dividing each of n×1 block rows that include a point into n. In the example of FIGS. 1 to 4, “1111” obtained by encoding the point occupation state of each of the four blocks obtained by dividing the 4×1 block row into four in the y axis is the third encoded data. The number of pieces of third encoded data corresponding to the number of n×1 block rows that include a point exist. The plurality of pieces of third encoded data are arranged in predetermined order.

When the value of the decoding information is 0, data following the header indicates the point occupation state of each of eight cubes obtained by dividing each side of a cube into two equal parts. When the point occupation state is indicated by one bit of 0 or 1, octree-structure data corresponding to one hierarchical layer is indicated by an 8-bit numerical value. When the number of division n of encoded data in the present embodiment is 8, all of the first encoded data, the second encoded data and the third encoded data are 8-bit numerical values, and, therefore, affinity with octree-structure data is high.

When each of the blocks at the next hierarchical layer (each of the blocks in FIG. 4) can be divided, encoded data obtained by encoding each of blocks that include a point is added after the third encoded data. For example, when each of the blocks in FIG. 4 is further divided, encoded data corresponding to the four blocks is added. Each of the blocks can be encoded similarly to FIGS. 1 to 4. Each of the pieces of encoded data of the four blocks is configured with a header, first encoded data, second encoded data and third encoded data. For each block, encoded data of the present embodiment or octree-structure data may be appropriately used.

When blocks of a lower hierarchical layer (blocks obtained by dividing each of the blocks in FIG. 4) can be divided, encoded data of blocks of the lower hierarchical layer may be added to each of the blocks, or encoded data may be collected for each hierarchical layer.

When decoding directions of a parent cube (the cube in FIG. 1) and child blocks (the blocks in FIG. 4) are the same, a header may not be attached to the encoded data of each of the blocks. For example, each of the pieces of encoded data of the four blocks in FIG. 4 is configured with the first encoded data, the second encoded data and the third encoded data. These pieces of encoded data are decoded in the order of the z-axis direction, the x-axis direction and the y-axis direction.

When the decoding direction is the same for the same hierarchical layer, a header may be given for each hierarchical layer. For example, a header is given to the first encoded data of a hierarchical layer, and the header is not given to remaining pieces of encoded data.

[Configuration of Decoding Apparatus]

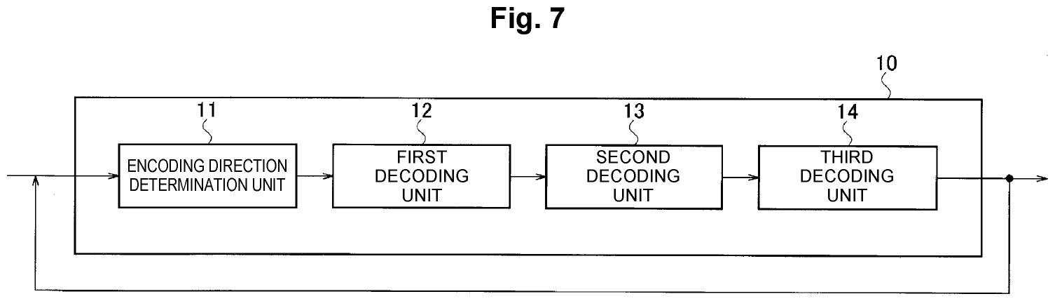

A decoding apparatus of the present embodiment will be explained with reference to FIG. 7. A decoding apparatus 10 shown in FIG. 7 is provided with a decoding direction determination unit 11, a first decoding unit 12, a second decoding unit 13 and a third decoding unit 14.

The decoding direction determination unit 11 determines directions corresponding to decoding order. The directions corresponding to decoding order will be referred to as a first direction, a second direction and a third direction below. Each of the first direction, the second direction and the third direction is any of the x-axis direction, the y-axis direction and the z-axis direction.

The first decoding unit 12 obtains the point occupation state of each of n n×n block plates obtained by dividing a cube into n in the first direction.

The second decoding unit 13 obtains the point occupation state of each of n n×1 block rows obtained by, according to the point occupation states of the n×n block plates, dividing n×n block plates that include a point into n in the second direction.

The third decoding unit 14 obtains the point occupation state of each of n blocks obtained by, according to the point occupation states of the n×1 block rows, dividing n×1 block rows that include a point into n in the third direction.

When the blocks can be further divided, encoded data of blocks that include a point, that is, the next blocks following the third encoded data in FIG. 5 is inputted to the decoding direction determination unit 11.

When the blocks cannot be divided, the point occupation states of the blocks indicate point cloud data.

[Process of Decoding Apparatus]

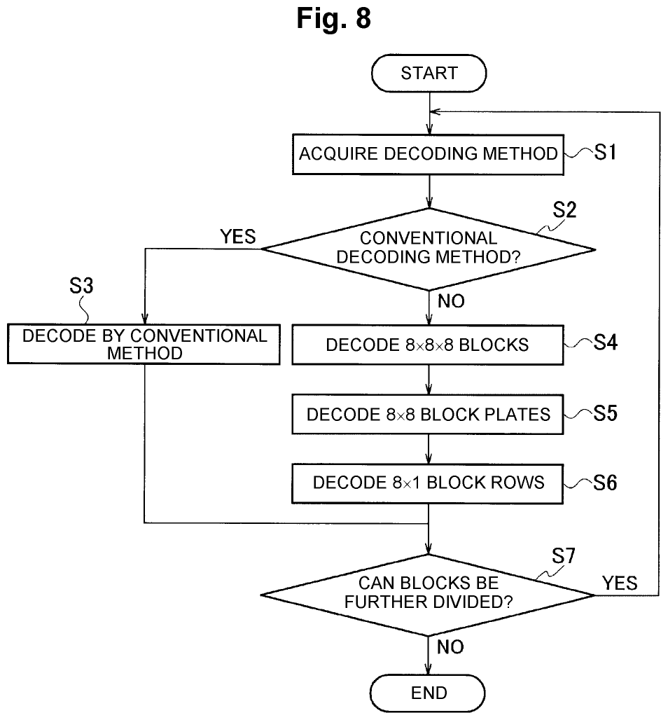

A flow of a process of the decoding apparatus 10 will be explained with reference to a flowchart of FIG. 8.

The decoding apparatus 10 acquires a decoding method for encoded data that has been inputted, at step S1, and determines whether the decoding method is a conventional method or not at step S2. The decoding method can be determined by referring to a header. A decoding direction can also be obtained from the header.

When the decoding method is the conventional method, data following the header is decoded by the conventional method at step S3.

If the encoded data is a decoding target of the decoding apparatus 10, the first decoding unit 12 obtains the point occupation states of 8×8 block plates obtained by dividing 8×8×8 blocks (a cube) in the first direction, from first encoded data at step S4. The number of division n (here, n=8) may be specified beforehand or may be specified by the header.

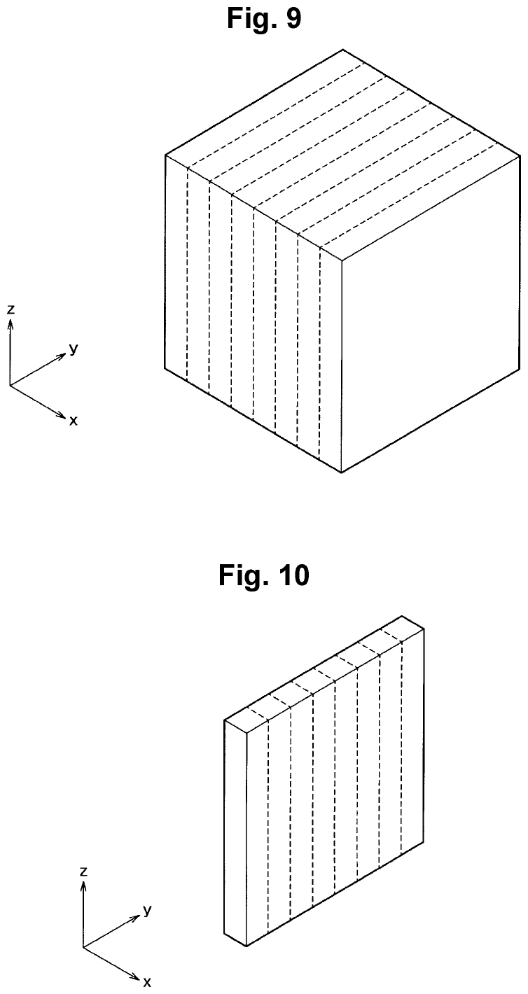

For example, when the first direction is the x axis, the cube is divided into eight 8×8 block plates in the x-axis direction and encoded as shown in FIG. 9. When the point occupation state of each of the 8×8 block plates is indicated by one bit, the cube is encoded with an 8-bit numerical value (0 to 255) with the positive direction of the x axis regarded as indicating a higher-order bit.

Here, 8×8 block plates that do not include a point are not targeted by a process at and after S5 below.

At step S5, for 8×8 block plates that include a point among the above 8×8 block plates, the second decoding unit 13 obtains the point occupation states of 8×1 block rows obtained by dividing each of the 8×8 block plates in the second direction, from the second encoded data.

For example, when the second direction is the y axis, each of the 8×8 block plates is divided in eight 8×1 block rows in the y-axis direction and encoded as shown in FIG. 10. When the point occupation state of each of the 8×1 block rows is indicated by one bit, each of the 8×8 block plates is encoded with an 8-bit numerical value (0 to 255) with the positive direction of the y axis regarded as indicating a higher-order bit.

Here, 8×1 block rows that do not include a point are not targeted by a process at and after S6 below.

At step S6, for 8×1 block rows that include a point among the above 8×1 block rows, the third decoding unit 14 obtains the point occupation states of blocks obtained by dividing each of the 8×1 block rows in the third direction, from the third encoded data.

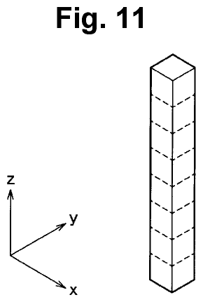

For example, when the third direction is the z axis, each of the 8×1 block rows is divided into eight blocks in the z-axis direction and encoded as shown in FIG. 11. When the point occupation state of each of the blocks is indicated by one bit, each of the 8×1 block rows is encoded with an 8-bit numerical value (0 to 255) with the positive direction of the z axis regarded as indicating a higher-order bit.

At step S7, it is determined whether the blocks obtained at step S6 can be further divided or not. If decoding has been performed by the conventional method, it is determined whether the blocks divided at step S3 can be further divided or not.

If the blocks can be further divided, the process from step S1 is repeated for encoded data of the blocks. Specifically, for data of the next and subsequent blocks in FIG. 7, the process from step S1 is repeated.

[Encoding Method]

In the present embodiment, a solid is divided into n in a direction in which correlation among point occupation states in divided solids is high, and encoding is performed based on the point occupation states in the divided solids. For example, a division direction is determined so that, when a solid is divided into n, the number of solids that do not include a point is large among divided n solids. At this time, an n×1 block row that can be divided into n (any of 1×1×n, 1×n×1 and n×1×1 is possible) is the minimum unit (the smallest solid).

Or alternatively, n blocks are arranged in one direction to create an n×1 block row such that correlation among point occupation states is high, and the n×1 block row is encoded according to the point occupation states of the blocks. On an upper hierarchical layer, n n×1 block rows are arranged in a direction in which correlation among point occupation states in a created block group is high, and the created block group is encoded according to the point occupation states in the n×1 block rows. On a further upper hierarchical layer, block groups on the lower hierarchical layer are arranged in a direction in which correlation among point occupation states is high and encoded. In any of the cases, encoding is performed based on the point occupation states of solids obtained by dividing a solid into n in one direction, and the minimum selectable unit of the present embodiment is an n×1 block row. However, depending on the point occupation state of an encoding target, there may be naturally a case where encoding is performed with a unit larger than the minimum unit of the embodiment. An encoding method in which the number of division n is 8 will be explained below.

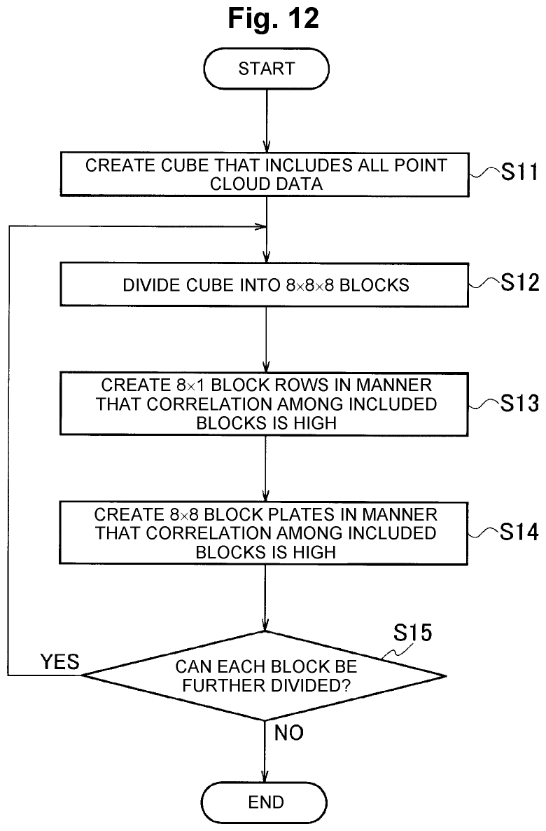

An example of a point cloud data encoding method will be explained with reference to a flowchart of FIG. 12.

At step S11, such a cube that includes all point cloud data and that one side corresponds to the smallest of 8 to the power of k is generated. The number of division n is 8, and the number of hierarchical layers is indicated by k.

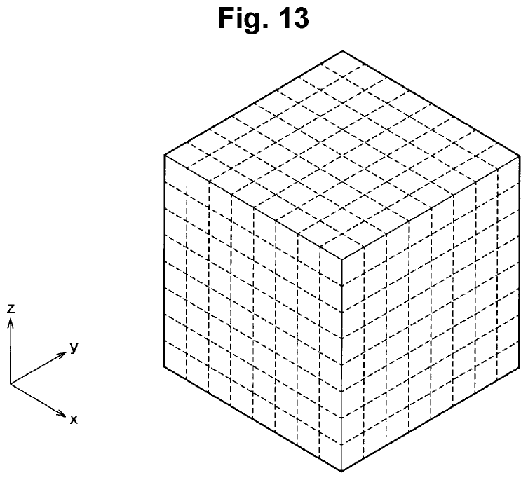

At step S12, the cube is divided into eight in each of the x-axis, y-axis and z-axis directions as shown in FIG. 13. That is, the cube is divided into 8×8×8 blocks.

At step S13, eight blocks are collected at a time in a direction in which correlation with regard to having points or not having points in the space is the highest among the x-axis, y-axis and z-axis directions to create 8×1 block rows. For example, the 8×1 block rows are created in a direction in which the number of 8×1 block rows each of which is configured only with blocks that do not include a point is large. In the example shown in FIG. 11, the 8×1 block rows are created by collecting blocks in the z-axis direction at a time. All the blocks are collected in the same direction (in the example of FIG. 11, the z-axis direction), and sixty-four 8×1 block rows are created.

At step S14, eight 8×1 block rows are collected at a time in any direction other than the direction in which the blocks have been collected at step S13 to create 8×8 block plates. For example, the 8×8 block plates are created in a direction in which the number of 8×8 block plates each of which is configured only with blocks that do not include a point is large. In the example shown in FIG. 10, the 8×8 block plates are created by collecting 8×1 block rows in the y-axis direction at a time. All the 8×1 block rows are collected in the same direction (in the example of FIG. 10, the y-axis direction), and eight 8×8 block plates are created.

When the 8×8 block plates are collected, the original cube is obtained.

Since order of directions in which the cube is divided and the point occupation state of each of divided solids are determined by the above process, the cube that includes point cloud data can be encoded.

Further, at step S15, it is determined whether the blocks can be further divided or not. When the blocks can be divided, the process from steps S12 to S14 is repeated for each of blocks that include a point, and each block on a lower hierarchical layer is encoded. The process from steps S12 to S14 is repeated k times.

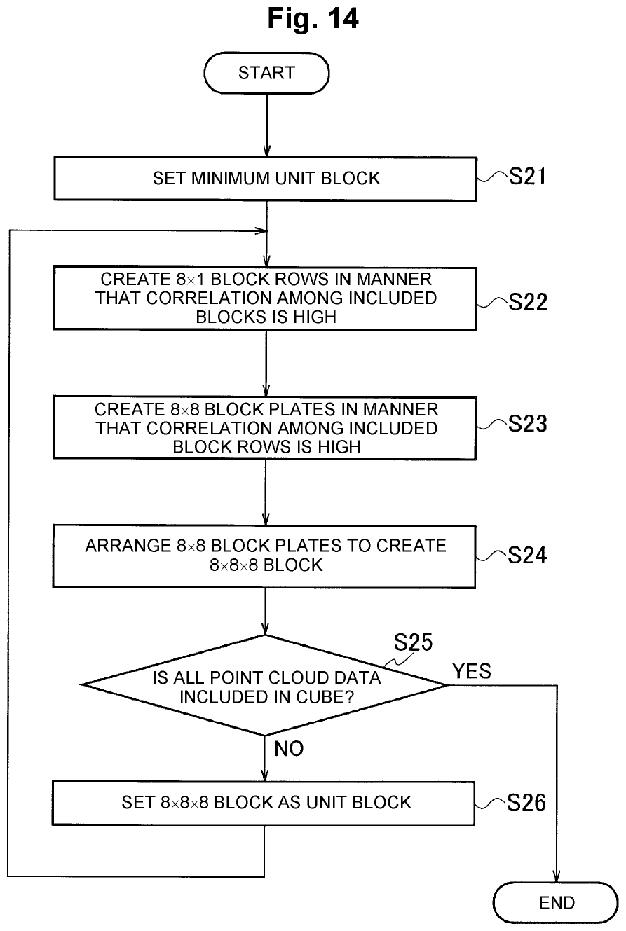

Another example of the point cloud data encoding method will be explained with reference to a flowchart of FIG. 14.

At step S21, a unit block is set to the minimum unit. For example, a cube that includes one point of point cloud data is set as the minimum unit block.

At step S22, eight unit blocks are collected at a time in a direction in which correlation among point occupation states in the space is high (any of the x-axis, y-axis and z-axis directions) to create 8×1 block rows.

At step S23, eight 8×1 block rows are collected at a time in a direction in which correlation among included block rows is high (a direction orthogonal to the direction of S22) to create 8×8 block plates.

At step S24, eight 8×8 block plates are collected to create a cube with 8×8×8 blocks.

At step S25, it is determined whether all the point cloud data is included in the cube or not.

If all the point cloud data is included in the cube, order of directions in which the cube is divided and the point occupation state of each of divided solids are determined, and, therefore, the cube that includes the point cloud data can be encoded.

If all the point cloud data is not included in the cube, the process from step S22 is repeated with an 8×8×8 block as a unit block at step S26.

The encoding method is not limited to the above method, and various encoding methods can be used. For example, encoding is performed in all the six orders, and order with the best encoding efficiency is adopted.

[Comparison with Octree]

Next, encoding efficiencies of encoded data that is decoded using the decoding method of the present embodiment and data encoded with an octree will be compared.

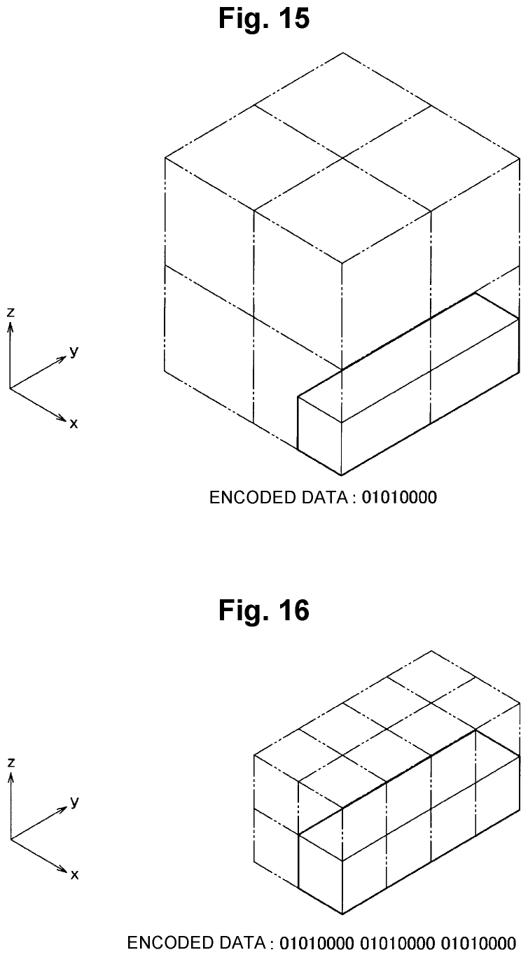

Explanation will be made on data obtained by encoding the cube including four blocks, which is shown in FIG. 1, with an octree with reference to FIGS. 15 and 16.

As shown in FIG. 15, in an octree structure, the cube is divided into eight cubes by dividing each side of the cube into two equal parts. The eight cubes are given numbers from 0 to 7 according to their positions. Specifically, two cubes vertically arranged on the left side of FIG. 15 are given numbers 0 and 1 in order from below; two cubes vertically arranged in the depth are given numbers 2 and 3 in order from below; two cubes vertically arranged on this side are given numbers 4 and 5 in order from below; and two cubes vertically arranged on the right side are given numbers 6 and 7 in order from below. As for the point occupation state of each of the cubes, a cube that includes a point is indicated by 1, and a cube that does not includes points is indicated by 0. When numerical values indicating the point occupation states of the cubes are arranged in the order of the numbers of the cubes, from the lowest-order bit, the original cube is indicated by “01010000”.

As shown in FIG. 16, each of the cubes with the numbers 4 and 6 is further divided into eight cubes and similarly encoded. Both of the cubes with the numbers 4 and 6 are indicated by “01010000”.

When numerical values obtained by encoding the cubes are arranged for each hierarchical layer, 24 bits of “01010000 01010000 01010000” is obtained. Encoded data of the present embodiment is 12 bits as described before, and there is a possibility that an amount of code can be reduced more than with an octree.

As explained above, from encoded data obtained by dividing a cube that includes three-dimensional point cloud data into n (n is an integer equal to or larger than 2) in the order of a first direction, a second direction and a third direction and encoding point occupation states, the decoding apparatus 10 of the present embodiment decodes the point cloud data. The decoding apparatus 10 is provided with: the decoding direction determination unit 11 determining the first direction, the second direction and the third direction corresponding to order of dividing the cube; the first decoding unit 12 obtaining the point occupation state of each of n n×n block plates obtained by dividing the cube into n in the first direction; the second decoding unit 13 obtaining, according to the point occupation state of each of the n×n block plates, the point occupation state of each of n n×1 block rows obtained by dividing the n×n block plate into n in the second direction; and the third decoding unit 14 obtaining, according to the point occupation state of each of the n×1 block rows, the point occupation state of each of n blocks obtained by dividing the n×1 block row into n in the third direction. Thereby, it may be possible to improve encoding efficiency in comparison with the case of expressing point cloud data by an octree structure. For example, at the time of expressing a three-dimensional object such as a floor or a pillar, encoding efficiency can be improved.

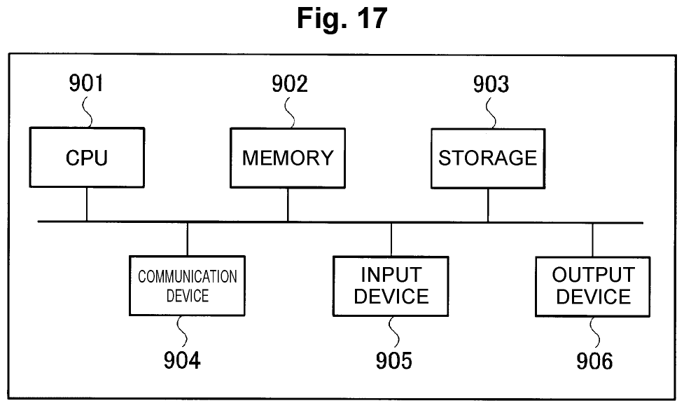

As the decoding apparatus 10 explained above, for example, a general-purpose computer system provided with a central processing unit (CPU) 901, a memory 902, a storage 903, a communication device 904, an input device 905 and an output device 906 as shown in FIG. 17 can be used. In the computer system, by the CPU 901 executing a predetermined program loaded onto the memory 902, the decoding apparatus 10 is realized. The program can be recorded to a computer-readable recording medium such as a magnetic disc, an optical disk or a semiconductor memory or distributed via a network.

### REFERENCE SIGNS LIST

10 Decoding apparatus

11 Decoding direction determination unit

12 First decoding unit

13 Second decoding unit

14 Third decoding unit

1. A decoding method for decoding encoded data obtained by encoding a cube that includes three-dimensional point cloud data, the decoding method comprising:
obtaining point occupation states of solids obtained after division in one direction, from the encoded data, wherein
the direction of the division is determined based on correlation among the point occupation states of the solids after the division.

2. A decoding method for decoding point cloud data from encoded data obtained by dividing a cube that includes three-dimensional point cloud data into n (n is an integer equal to or larger than 2) in order of a first direction, a second direction and a third direction and encoding point occupation states, the decoding method comprising:
determining the first direction, the second direction and the third direction according to order of decoding;
obtaining a point occupation state of each of n first block groups obtained by dividing the cube into n in the first direction;
obtaining, according to the point occupation state of each of the first block groups, a point occupation state of each of n second block groups obtained by dividing the first block group into n in the second direction; and
obtaining, according to the point occupation state of each of the second block groups, a point occupation state of each of n blocks obtained by dividing the second block group into n in the third direction.

3. The decoding method according to claim 2, wherein n is 8.

4. The decoding method according to claim 2, wherein encoded data obtained by encoding each of the blocks of a next hierarchical layer is decoded.

5. The decoding method according to claim 4, wherein the encoded data holds information for determining the order of decoding for each hierarchical layer.

6. A decoding apparatus for decoding point cloud data from encoded data obtained by dividing a cube that includes three-dimensional point cloud data into n (n is an integer equal to or larger than 2) in order of a first direction, a second direction and a third direction and encoding point occupation states, the decoding apparatus comprising a processor configured to perform operations comprising:
determining the first direction, the second direction and the third direction according to order of decoding;
obtaining a point occupation state of each of n first block groups obtained by dividing the cube into n in the first direction;
obtaining, according to the point occupation state of each of the first block groups, a point occupation state of each of n second block groups obtained by dividing the first block group into n in the second direction; and
obtaining, according to the point occupation state of each of the second block groups, a point occupation state of each of n blocks obtained by dividing the second block group into n in the third direction.

7. (canceled)

8. The decoding method according to claim 3, wherein encoded data obtained by encoding each of the blocks of a next hierarchical layer is decoded.
